(19) United States
(12) Patent Application Publication
(10) Pub. No.: US 2024/0232594 A1
(43) Pub. Date: Jul. 11, 2024

(54) GENERATING AND GLOBALLY TUNING APPLICATION-SPECIFIC MACHINE LEARNING ACCELERATORS

(71) Applicant: Google LLC, Mountain View, CA (US)

(72) Inventors: Yang Yang, Mountain View, CA (US); Claudionor Jose Nunes Coelho, Jr., Redwood City, CA (US); Hao Zhuang, San Jose, CA (US); Aki Oskari Kuusela, Palo Alto, CA (US)

(21) Appl. No.: 18/289,292

(22) PCT Filed: May 3, 2021
(86) PCT No.: PCT/US2021/030416

§ 371 Date: Nov. 2, 2023

(51) Int. Cl. G06N 3/063; G06N 3/0464; G06N 3/082

(52) U.S. Cl. CPC G06N 3/063; G06N 3/0464; G06N 3/082

(57) ABSTRACT

Methods, systems, and apparatus, including computer-readable media, are described for globally tuning and generating ML hardware accelerators. A design system selects an architecture representing a baseline processor configuration. An ML cost model of the system generates performance data about the architecture at least by modeling how the architecture executes computations of a neural network that includes multiple layers. Based on the performance data, the architecture is dynamically tuned to satisfy a performance objective when the architecture implements the neural network and executes machine-learning computations for a target application. In response to dynamically tuning the architecture, the system generates a configuration of an ML accelerator that specifies customized hardware configurations for implementing each of the multiple layers of the neural network.

### BACKGROUND

This specification generally relates to integrated circuits used to perform machine-learning computations.

Neural networks are machine-learning models that employ one or more layers of nodes to generate an output, e.g., a classification, for a received input. Some neural networks include one or more hidden layers in addition to an output layer. Some neural networks can be convolutional neural networks (CNNs) configured for image processing or recurrent neural networks (RNNs) configured for speech and language processing. Different types of neural network architectures can be used to perform a variety of tasks related to classification or pattern recognition, predictions that involve data modeling, and information clustering.

A neural network layer can have a corresponding set of parameters or weights. The weights are used to process inputs (e.g., a batch of inputs) through the neural network layer to generate a corresponding output of the layer for computing a neural network inference. A batch of inputs and set of kernels can be represented as a tensor, i.e., a multi-dimensional array, of inputs and weights. A hardware accelerator is a special-purpose integrated circuit for implementing neural networks. The circuit includes memory with locations corresponding to elements of a tensor that may be traversed or accessed using control logic of the circuit.

Designing a specialized hardware accelerator is work intensive and time consuming. For example, the design process often requires months of effort and can include multiple design iterations. Further, to meet application-specific performance and power targets, the design process requires a strategy to map a target application to the underlying hardware. While computation graphs of neural networks are static, the mapping effort can involve several design parameters that influence the actual performance of the circuit. Also, manual exploration of the design space is often prohibitive due to the sheer size of the different settings and the inter-relationship between different parameters.

### SUMMARY

This specification describes techniques for globally-tuning a data processing architecture and automatically generating an application-specific machine-learning (ML) accelerator based on the tuned architecture. The architecture can be a candidate architecture selected based on a set of application level objectives. Example application level objectives can include processor utilization, power consumption, data throughput, and latency. In some cases, the objectives represent a user's desired performance attributes of an example ML accelerator. Some (or all) of the objectives may be received as user inputs to an example hardware accelerator design system. The design system may also determine one or more of the objectives independent of user input.

The system uses the application level objectives (e.g., one or more inputs) to globally tune and dynamically optimize a candidate architecture. For example, the architecture may be tuned and optimized for running a particular type(s) of neural network(s) so as to realize efficiencies in areas such as power consumption and processor utilization. The accelerator design system uses an architecture-specific cost model to tune various aspects of the architecture. An output of the cost model is used to define a final configuration of the accelerator. After optimization and tuning, the system automatically generates hardware configurations that include various architecture features, including scheduling/mapping options, for generating an application-specific (ML) accelerator that is optimized to implement a specified neural network in hardware.

One aspect of the subject matter described in this specification can be embodied in a computer-implemented method for generating an application-specific machine-learning (ML) accelerator. The method includes selecting an architecture that represents a baseline processor configuration and generating, by an ML cost model, performance data about the architecture at least by modelling how the architecture executes computations of a first neural network that includes multiple layers. The method includes, based on the performance data, dynamically tuning the architecture to satisfy a performance objective when the architecture implements the first neural network and executes machine-learning computations for a target application. The method also includes, generating a configuration of an ML accelerator in response to dynamically tuning the architecture. The configuration specifies customized hardware configurations for implementing each of the multiple layers of the first neural network.

These and other implementations can each optionally include one or more of the following features. For example, in some implementations, the method further includes generating an application-specific hardware ML accelerator based on the customized hardware configurations. Additionally, the application-specific hardware ML accelerator can be optimized to implement each of the different layers of the neural network when the neural network is used to execute computations for the target application.

The performance objective includes multiple discrete objectives and generating the application-specific ML accelerator includes: generating an application-specific hardware ML accelerator that is configured to satisfy each discrete objective of the multiple discrete objectives when the application-specific hardware ML accelerator executes computations for the target application. In some implementations, generating the performance data includes: modeling, by the ML cost model, use of the architecture to execute each layer of the multiple layers of the first neural network; and in response to modelling use of the architecture to execute each layer, generating, by the ML cost model, performance parameters of the architecture for each of the multiple layers.

The performance parameters can correspond to each discrete objective of the multiple discrete objectives; and the multiple discrete objectives includes at least one of a threshold processing latency, a threshold power consumption, a threshold data throughput, and a threshold processor utilization. In some implementations, dynamically tuning the architecture includes: determining a mapping of computations for an input tensor that causes the application-specific hardware ML accelerator to utilize a threshold percentage of hardware computing units of the hardware ML accelerator; and dynamically tuning the architecture based on the determined mapping.

Dynamically tuning the architecture can include: dynamically tuning the architecture based on operations performed by each of multiple ML cost models of a global tuner; and dynamically tuning the architecture based on operations performed by at least one of a random tuner or a simulated annealing tuner of the global tuner. In some implementations, the architecture represents one or more hardware blocks of an integrated circuit and dynamically tuning the architecture includes: dynamically tuning the architecture to satisfy a respective performance objective for each of the one or more hardware blocks when the architecture implements the first neural network to execute computations for the target application.

The configuration of the hardware ML accelerator specifies customized software configurations for the first neural network; and generating the application-specific hardware ML accelerator includes, generating the application-specific hardware ML accelerator based on the customized hardware configurations and the customized software configurations. In some implementations, the ML cost model is an architecture-aware cost model that includes one or more individual analytical models; and the architecture-aware cost model is configured to estimate performance of the architecture based on a deterministic dataflow of data that is processed using the architecture.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by a data processing apparatus, cause the apparatus to perform the actions.

The subject matter described in this specification can be implemented in particular embodiments so as to realize one or more of the following advantages.

The disclosed techniques provide a framework that can be used to expedite the architecture exploration process for defining optimized hardware and software configurations, including efficient scheduling/mapping of operations for implementing a neural network on a hardware circuit. Based on this process, a hardware design system can automatically generate an output configuration that defines system-wise optimized hardware mappings for a given set of PPA (performance, power, area) constraints. The PPA constraints can be hardware accelerator performance thresholds relating to at least processor utilization, power consumption, latency, block size, and/or data throughput.

The design system can identify an example network model with a fixed number of layers and determine optimal attributes of an identified hardware architecture (e.g., systolic array, compute tiles, etc.) including attributes of its micro-architecture, such as block connections, hardware layout, or memory. In addition to these optimized hardware attributes, the design system determines efficient scheduling and data allocations for layer-by-layer processing, such that an application-specific ML accelerator can be generated to meet (or exceed) user or system defined requirements for layer specific processing, while also consuming minimal amounts of power and circuit area.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a block diagram of an example computing system for generating and globally tuning a machine-learning accelerator.

FIG. 2 is a block diagram showing an example system for globally tuning an application-specific machine-learning accelerator.

FIG. 3 illustrates an example framework for tuning a multi-layer neural network.

FIG. 4 is a flow diagram of an example process for tuning and optimizing a graph execution schedule of a multi-layer neural network.

FIG. 5 is a flow diagram of an example process used to generate and globally tune a machine-learning accelerator.

FIG. 6 is a block diagram of an example application-specific hardware accelerator generated using the system of FIG. 1.

FIG. 7 illustrates examples of input tensor, a weight tensor, and an output tensor.

Like reference numbers and designations in the various drawings indicate like elements.

### DETAILED DESCRIPTION

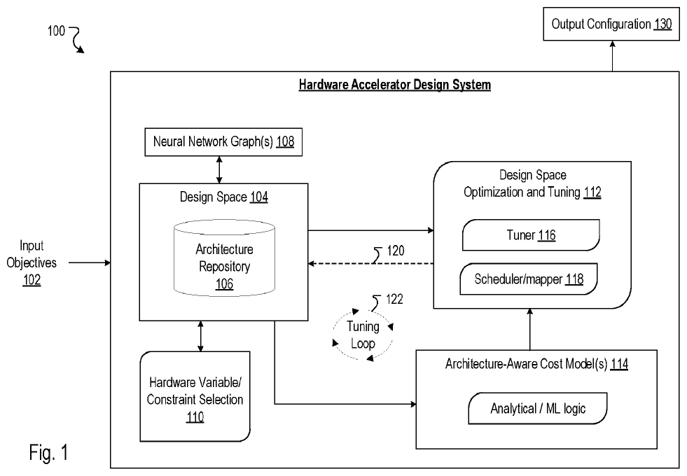

FIG. 1 is a block diagram of an example hardware accelerator design system 100 (“system 100”). In general, system 100 can include processors (e.g., central processing units (CPUs), graphics processing units (GPUs), special-purpose processors, etc.), memory, and/or data storage devices that collectively form processing resources used to execute functions for globally tuning and generating customized hardware machine-learning accelerators.

As described below, using one or more input objectives 102, system 100 is configured to develop and output a design configuration for generating an example hardware accelerator. The hardware accelerator can be implemented as a special-purpose or application-specific hardware circuit that is optimized to execute a particular type of machine-learning task. For example, the application-specific circuit may be a machine-learning (ML) hardware accelerator configured to implement or run a multi-layer neural network.

More specifically, the application-specific circuit may be uniquely tuned and/or optimized in accordance with different application objectives, such as one or more inputs specified by a user. For example, when implementing a particular type of neural network (e.g., a multi-layer CNN), a candidate data processing architecture for an application-specific ML circuit may be optimized to achieve (or exceed) threshold performance objectives relating to processor utilization, power consumption, data throughput, and/or latency.

As used in this document a data processing “architecture” can refer to a hardware circuit architecture, a software/neural architecture, or both. In this manner, tuning and optimizing an architecture can include tuning attributes of the hardware architecture as well as tuning attributes of the neural architecture, such that a resulting architecture is optimized (e.g., fully optimized) to perform a given machine-learning task in accordance with each different application objective that may be receive or determined by system 100.

System 100 includes control logic for constructing and managing a design space 104. The design space 104 may be constructed based on a combination of hardware devices and software routines executed at system 100. For example, the control logic may be implemented as a system controller or host device that executes programmed instructions to manage various design space operations. The operations of design space 104 can involve processing multiple design items or parameters required for tuning a candidate architecture.

In general, the system 100 uses the control logic to manage activities and operations of design space 104. In addition to optimizing architectures for a given ML task, in some implementations, the control logic of system 100 may itself be based on a ML model. For example, the ML model may be trained to process the design inputs and control parameters necessary for tuning a candidate architecture based on a set of input objectives. In some implementations, the control logic executes or applies an example optimization algorithm that tunes a candidate architecture in accordance with a set of input objectives as well as operations performed by an example cost model (described below).

A candidate architecture is selected at least from an architecture repository 106 of system 100. The system 100 can identify or select a candidate architecture from the architecture repository 106 based at least on an input object 102. The architecture repository 106 includes information describing multiple different hardware architectures used to generate an application-specific hardware ML accelerator.

For example, a first hardware architecture accessed via the architecture repository 106 may define a systolic array architecture, whereas a second, different hardware architecture accessed via the architecture repository 106 may define a hardware architecture based on an arrangement of compute tiles. Similarly, a third architecture accessed via the architecture repository 106 may define a hardware architecture based on respective sets of tightly coupled data processing lanes that form distinct vector processing units (VPUs), whereas a fourth architecture accessed via the architecture repository 106 may define a hardware architecture that includes at least two vector processor cores that interact with a large shared scratchpad memory and a matrix computation unit.

Candidate architectures selected for optimization and tuning can be a combination of a hardware circuit architecture, e.g., obtained from the architecture repository 106, and a neural architecture. The neural architecture may be obtained from a network graph module 108 that includes multiple different types of neural network graphs. For example, the system 100 can select a candidate architecture based on the input objective 102, an example hardware layout of an integrated circuit (IC), and an example neural network graph.

In some implementations, the system 100 selects a candidate architecture based on one or more input objectives 102 that bias the system toward selection of a particular hardware architecture for a given neural network architecture. For example, the system 100 can select the candidate architecture based on one or more hardware variables. The hardware variables can represent control parameters that constrain architecture selection and cause the design space 104 to, for example, select a particular type of hardware architecture from repository 106 for a given neural architecture obtained from graph module 108.

System 100 includes an optimization and tuning module 112 that interacts with one or more cost models to globally-tune an example data processing architecture. For example, system 100 includes an architecture-aware cost model 114 that can include one or more individual data models 114. In some cases, each of these individual data models is a respective cost model 114 that is configured to execute ML based analytics for tuning a candidate architecture based on a set of input objectives. The architecture-aware cost model 114 estimates performance of a candidate architecture based on a deterministic dataflow of data that is processed using the architecture.

In some implementations, system 100 includes respective cost models 114 that are based on one of two types of cost models, an analytical cost model or ML based cost model. Both models can receive the same input and produce the same output, as discussed in the optimization loop described below. In general, the difference between these two types of cost models is how each model predicts its cost internally. There are various differences between the analytical cost model and ML based cost model.

For example, the analytical cost model can be a roofline based model that considers various “ceilings” based on a set of hardware mapping parameters and neural network graphs. The analytical cost model does not require training data. With a given input, the analytical cost model uses “internal logic” to derive the bottlenecks and output the cost. Internally, one or more hardware blocks used to implement the analytical cost model can be configured to share a “cost module.” The shared cost module is operable to produce a cost given the hardware mapping parameters and the neural network computation to be run on the hardware blocks. In some cases, the analytical cost models yield particularly accurate cost outputs for applications that have deterministic dataflows.

The ML based cost model requires labeled data to train a machine-learning model that can predict at least a latency and throughput. For example, the machine-learning model can be trained to predict cost values for different application level objectives, including one or more of the PPA constraints. The ML based cost model can be implemented using supervised learning and multi-level perceptrons. In some implementations, the training data of the ML based cost model is obtained by high level synthesis and RTL simulations. To overcome the discrete nature of the inputs, the inputs of the ML based cost model can be converted to embeddings which are learned using standard techniques such as stochastic gradient descent. In some cases, the ML based cost model is trained offline. The trained ML based cost model is used during the optimization loop (described below) to dynamically optimize a candidate architecture.

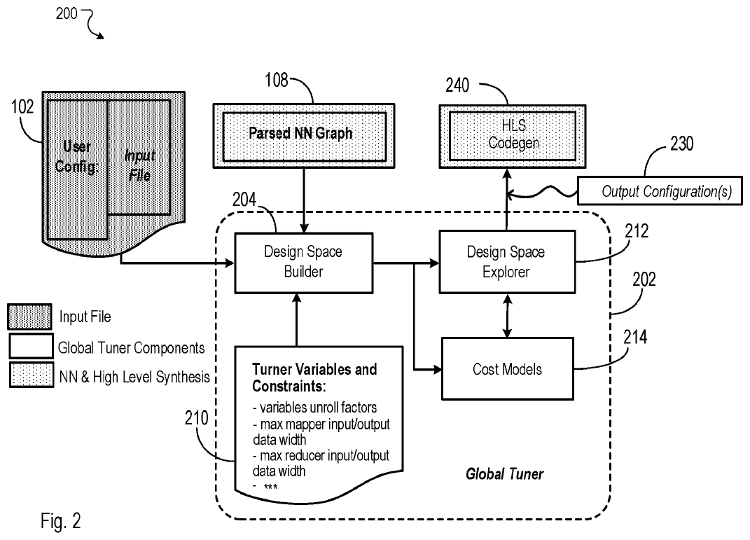

Each of the optimization and tuning module 112 and a set of cost models 114 can function as an extension of the design space 104. In some implementations, the optimization and tuning module 112 and a set of cost models 114 represent a global tuner that tunes attributes of both the hardware blocks and neural network of a candidate architecture. The control logic of design space 104 can be used to control or manage operations of the global tuner. For example, the global tuner can interact with different aspects of the design space 104 (e.g., variables and constraints) to tune a candidate architecture based on control signals generated using the control logic. This is described in more detail below with reference to FIG. 2.

The optimization and tuning module 112 includes an example tuner 116 and an example scheduler/mapper 118. In some implementations, the tuner 116 and the scheduler/mapper 118 interact to execute example tuning and optimization tasks of the module 112 (described below). As noted above, a data processing architecture can be a combination of a hardware circuit architecture, e.g., obtained from the architecture repository 106, and a neural architecture obtained from the neural network graph module 108. The hardware architecture can include multiple individual hardware blocks that each include hardware features such as systolic array cells, vector processor lanes, or individual compute tiles.

The tuner 116 and the scheduler/mapper 118 cooperate to: i) configure a candidate mapping of neural network layers to one or more hardware blocks and ii) for this candidate mapping, tune a respective micro-architecture of each hardware block based on one or more application objectives 102. In this manner, the optimization and tuning module 112 is configured to tune a respective micro-architecture of each hardware block such that a given hardware block is optimized to execute one or more layers of a neural network.

To achieve a desired performance goal, the optimization and tuning module 112 can interact with the architecture-aware cost model 114 to iterate through the process of configuring the candidate mappings and tuning the micro-architectures of each hardware block. This tuning iteration can involve signal communications, e.g., via an optional data path 120, from optimization and tuning module 112 to the design space 104. The communications may be to obtain new inputs, variables, constraints, or architecture features for augmenting a hardware block of a candidate architecture based on, for example, performance estimates generated by cost model 114. System 100 can include a tuning loop 122 that represents the iterative process.

System 100 generates an example output configuration 130 based on the processing operations of design space 104, the optimization and tuning module 112, and the architecture-ware cost model 114. As described below, system 100 can automatically generate an application-specific ML hardware accelerator (e.g., an integrated circuit) based on the output configuration 130.

FIG. 2 is a block diagram showing an example system 200 that includes a global tuner 202. In some cases system 200 is included within system 100 as a sub-system of software/compute modules or hardware circuits with programmed instructions that are executable by one or more processing devices.

The operations of system 200 provide a global tuning framework for automatically generating application-specific ICs customized to perform learning tasks such as training and inference for a target application. In some implementations, the target application (or device) is a customized hardware accelerator with a fixed hardware configuration. In some other implementations, the target application is a type of workload relating to image classification, object detection, autonomous vehicle navigation, graphics processing, or scientific computing.

Global tuner 202 is configured to globally tune/optimize a candidate architecture, in accordance with different application objectives 102, to generate an application-specific ML hardware accelerator. The global tuner 202 includes a design space builder 204 that constructs a design space 104 based on one or more tuner variables and constraints 210. The design space builder 204 communicates with a design space explorer 212 and one or more cost models 214 of global tuner 202. Cost models 214 correspond to the individual models of the architecture-aware cost model 114 described above.

Based on the parsed neural network graphs of module 108, the design space builder 204 and design space explorer 212 can interact to implement a neural architecture search (NAS) system for selecting a neural network architecture (“neural architecture”) that will perform optimally for a target application. The NAS may employ various search techniques, such as techniques based on reinforcement learning, evolutionary search, differentiable search, and the like. The design space builder 204 and design space explorer 212 may employ a similar approach to explore different hardware architectures that can be efficiently tuned and optimized for a target application.

The design space builder 204 and design space explorer 212 implements the NAS and hardware architecture search techniques based on one or more tuner variables and constraints 210. The tuner variables and constraints 210 include various unroll factors, max mapper input/output data width, or max reducer input/out data width. As described above, a neural network layer can have a corresponding set of kernels (e.g., weights/parameters). A kernel can be a convolution kernel that has 4 dimensions: C-input channel; K-output channel; R-kernel height; and S-kernel width. An example convolution operation can be expressed as a nested loop using the four dimensional parameters (C, K, R, S). A set of kernels is represented as a multi-dimensional tensor and the nested loop can be used to traverse different dimensions of the tensor. In this context, the unroll factors correspond to an unrolling of each of the nested loops. The global tuner 202 supports unrolling of the nested loops for all of the unroll factors and can tune a candidate architecture with respect to these factors.

The mapper and reducer input/output data width affect how a large tensor is reduced into smaller pieces that are mapped to a given compute tile or cell. For example, an input tensor and an output tensor can be quite large, and these tensors are not produced all at once. To reduce the area and power of a hardware accelerator that processes these tensors, system 100 can utilize tensor tiling to break down an input tensor and an output tensor into multiple smaller pieces. For example, the system 100 can break down (or reduce) a large input tensor into smaller pieces based on a mapping constraint. The mapping constraint may be tied to objectives such as power, area, latency, and/or throughput. The global tuner 202 can use these objectives to determine a configuration and size of a set of compute tiles for a candidate architecture. The global tuner 202 can map computations for the different pieces of the input tensor to a given tile in a set of compute tiles.

The max mapper input/output data width and max reducer input/out data width are constraints that directly impact data throughput of a candidate architecture. The tuner variables and constraints 210 can include other items that are pertinent to exploring candidate architectures for generating a hardware ML accelerator customized to run a given neural network for a target application. In some implementations, smaller tile sizes require longer data transfer times, so overall chip performance can also come into play here. All these different tuner variables and constraints 210 can result in a different hardware design, with implications on the performance, power, and area. Thus, the global tuner 202 forms a design space from these variables/constraints and strikes a balance between performance, power, and area by choosing the optimal parameters for customizing hardware and neural architectures.

The global tuner 202 can dynamically tune a candidate architecture based at least on operations performed by each individual ML cost model 214. In some implementations, the global tuner 202 dynamically tunes a candidate architecture based on operations performed by at least one of: i) a random search tuner; ii) a simulated annealing tuner; or iii) a progressive tuner. Each of the random search tuner, the simulated annealing tuner, and the progressive tuner correspond to tuner 116 described above. For block partition models, the global tuner 202 implements a particular tuning trajectory associated with the simulated annealing tuner. Each of the random tuner, and the simulated annealing tuner, and the progressive tuner may be implemented in software, hardware, or both. Functionality associated with each of these tuners may be integrated in tuner 116, which is implemented in global tuner 202.

Global tuner 202 uses the random search tuner to randomly sample the search space to obtain a trial configuration, such as a baseline processor configuration of a candidate architecture. The cost of running a target application on the trial configuration/architecture is obtained by querying a performance and power cost model of the ML cost models 214.

The simulated annealing can be implemented as a tuner in the global tuner 202 and is a probabilistic technique for approximating a global optimum of a given function. At each step, this tuner considers a neighbor hardware design point d′ of a current hardware design point d and probabilistically decides whether to move the current design point toward design point d′ or to stay with the design point d. A temperature variable is created to control the acceptance probability. The simulated annealing tuner is configured to repeat these steps until its probability outcomes indicate arrival at an optimal design point for a target application. For example, a probability score that exceeds a threshold score can indicate that a particular design point performs optimally for a target application relative to a given set of constraints.

A neighbor hardware design point may be randomly generated. In some implementations, a neighbor hardware design point has similar or very similar hardware parameter selections (e.g., unrolling, tiling, mapping, or scheduling) as a current hardware design point. The similarity of the parameter selections may be characterized by an amount (or percentage) of overlap in hardware parameter selections between the two design points. In some other implementations, a neighbor hardware design point can have one or more of the same hardware parameter selections as a current hardware design point.

Global tuner 202 uses the progressive tuner to implement a progressive search methodology of an example design space, such as a design space of the NAS. This progressive search methodology can be used to reduce a design space exploration time for tuning a candidate architecture. In some implementations, the global tuner 202 executes the progressive search methodology to explore the design space as a step in designing and tuning ML hardware to meet (or exceed) certain throughput requirements such as a fixed data rate input to a machine-learning block of an integrated circuit. The progressive search methodology can include at least the steps of: i) initializing a baseline design as a minimal design for all neural network layers and ii) querying a cost model 214 to identify a bottleneck layer which has a data throughput that is lower than a data rate requirement. If the cost model 214 does not identify or indicate a bottleneck and/or the global tuner 202 determines that no layer of the neural network operates as a bottleneck, then execution of the search methodology ends.

The progressive search methodology may further include the steps of: iii) exhaustively exploring the search space with reference to the bottleneck to determine a design configuration that minimizes the bottleneck by meeting (or exceeding) the throughput requirements, while having the lowest cost on overall model performance; and iv) using the design configuration determined at step iii) as the new baseline design and then proceeding back to step ii). In some implementations, the baseline design is baseline processor configuration that includes minimal hardware (and neural) architecture/design parameters for running all layers of a given neural network. Exhaustively exploring the search space includes iteratively exploring different design configurations, by using each design configuration to implement a multi-layer neural network, assessing a respective data throughput of each design configuration, and computing a respective cost value for each of the different design configurations

In the example of FIG. 2, an input objective 102 can be user defined, system defined, or both. For example, the input objective 102 can be received as a user configuration file or as a system generated input file. The configuration or input file can specify various application level objectives 102 that, for example, are derived from a set of PPA constraints. For example, an input file can include a set of application level objectives such as processor utilization, power consumption, data throughput, hardware block size, and/or latency. The input file also includes respective hardware accelerator performance thresholds for each application level objective.

In some implementations, an input file includes an objective 102 that indicates a target application requires multiple vector operations. Based on this indication, the control logic can trigger a hardware variable 110 of design space 104 to be set as a vector parameter (vector ctrl). The design space 104 can use the vector_ctrl parameter to constrain selection of a candidate architecture to, for example, architectures that include multiple vector processing lanes that form tightly coupled VPUs.

In the example of FIG. 2, some (or all) of the cost models 214 execute ML based analytics for tuning the candidate architecture. In accordance with a set of input objectives 102, the global tuner 202 tunes the hardware and neural architecture of a candidate architecture based on one or more optimization algorithms. For example, the global tuner uses the cost models 214 to model use of the candidate architecture to execute each layer of a multi-layer neural network with reference to a certain hardware block(s) of the neural network. In response to modeling use of the architecture to execute each layer, the ML cost models 214 generate performance parameters that describe how the architecture performs for each layer.

In some implementations, the optimization algorithm is used to implement a cost model interaction loop, e.g., an optimization loop. For example, the optimizer or global tuner 202 (e.g., simulated annealing, progressive, random, etc.) can generate a set of hardware mapping parameters, such as number of PEs, systolic array dimension, etc. The hardware mapping parameters together with the neural network graph, which contains the layer dependencies and quantization schemes (e.g., fixed), are sent to the cost model 214. The cost models 214 produce a cost, such as latency, throughput, and power, based on the input. The cost output of the cost models can be fed back to the optimizer as a step in the optimization loop. The optimizer can process the cost output and determine a next hardware mapping strategy to explore. The global tuner 202 can iterate this optimization loop until a convergence condition is met or the search space is fully explored.

In some implementations, a first cost model 214 of global tuner 202 is used to compute performance estimates/parameters about hardware attributes of the candidate architecture, whereas a second cost model 214 is used to compute performance estimates/parameter about the neural network implemented on the candidate architecture. The first and second cost models 214 may be the same or different. The cost models 214 can use a single optimization algorithm to compute performance estimates for tuning the architecture and optimizing the candidate architecture's performance. In some other implementations, the cost models 214 use different optimization algorithms to compute performance estimates for optimizing various aspects of the architecture's performance.

The global tuner 202 can use at least the design space builder 204, design space explorer 212, and cost models 214 to implement different design space and optimization strategies for various hardware and neural network architectures that are explored. For example, within each hardware block of a candidate architecture, the global tuner 202 explores different implementations targeting one layer specifically such as layer specific tiling and tuning of systolic array dimensions. The global tuner 202 can explore layer transformation to increase parallelization. For example, the global tuner 202 can transform a dense/1×1 convolution to n× n convolution to increase throughput and/or utilization of compute units across one or more hardware blocks.

In some implementations, based on its optimization algorithm, a cost model 214 computes a utilization estimate from indications that a dense convolution is assigned to a single compute unit of a hardware block that includes several compute units. The global tuner 202 can compare the utilization estimate to a utilization threshold specified by an application objective 102 (or constraint 210). The global tuner 202 determines whether the computed utilization estimate is below the threshold. The global tuner 202 can transform a dense/1×1 convolution to n× n convolutions to increase utilization of the compute units across a given hardware block in response to determining that a computed utilization estimate is below the threshold. The utilization estimate is a performance parameter (or estimate) generated by the cost model 214.

For a multi-dimensional array of processing engines (e.g., cells, tiles, or processing lanes), the global tuner 202 can determine an optimal size/area and expected power density required to achieve a desired performance objective. The global tuner 202 can vary the number processing engines (PEs) in each dimension of the array based on the determined size. The systems 100, 200 are configured such that one or more deep hardware customizations for one layer of a neural network does not preclude or adversely affect efficient running or operation of other layers of the neural network.

The global tuner 202 generates an output configuration 230 in response to tuning the candidate architecture. The output configuration 230 is used to automatically generate an application-specific ML accelerator. The output configuration 230 can represent an ML model (or algorithms) and corresponding architecture configuration. The system 200 translates data representing the output configuration 230 to High level synthesis (HLS) code using an example code generation module 240. For example, the code generation module 240 can create firmware implementations of ML algorithms for a hardware accelerator using high level synthesis language (HLS).

In general, the global tuner 202 is used to generate one or more application-specific ML accelerators that are fully customized for target applications. For example, the customizations can include items such as heterogeneous quantization and microarchitectures that are tailored for one or more neural network layers. In some implementations, the global tuner 202 and system 200 are used to generate a customized architecture at least by identifying optimal hardware parameters, such as microarchitecture, spatial mapping, and temporal mapping for optimizing an overall architecture for a set of PPA constraints (e.g., objectives 102).

Hardware features may be separated on or inside a chip. Optimizing the spatial mapping of an architecture involves hardware blocks that are used to run different neural network operations being spatially separated inside a chip or integrated processor block. For example, a candidate architecture may be optimized for spatial mapping by using a particular arrangement of dedicated hardware blocks to execute dedicated operations in a neural network. This mapping allows hardware blocks to be tailored for specific algorithms or computational patterns.

Relative to other designs, architectures with optimized spatial mapping can provide improvements in performance and energy efficiency. The improvements may be realized at least from the arrangement of dedicated hardware blocks tailored to implement a specific algorithm or computing pattern. In some implementations, one or more dedicated hardware blocks are configured to process fixed dimension tensors, support a fixed quantization scheme, and tailored for a particular neural network layer.

Optimizing the temporal mapping (307) of an architecture involves a hardware block being time-shared among different operations in a neural network. For example, a candidate architecture may be optimized for temporal mapping by reusing the same hardware block to execute a wide variety of different operations in neural networks. Being more general in its use of a given hardware block, this approach can improve the programmability of the hardware. Moreover, this approach can give application developers more flexibility in terms of the neural networks that can be run on the hardware. In some examples, optimized temporal mapping provides for time sharing of different layers in the same hardware block and support of multiple quantization schemes.

The customization can result in an application-specific ML accelerator that consumes significantly less power and area when compared to other processing devices that are not customized for a target application.

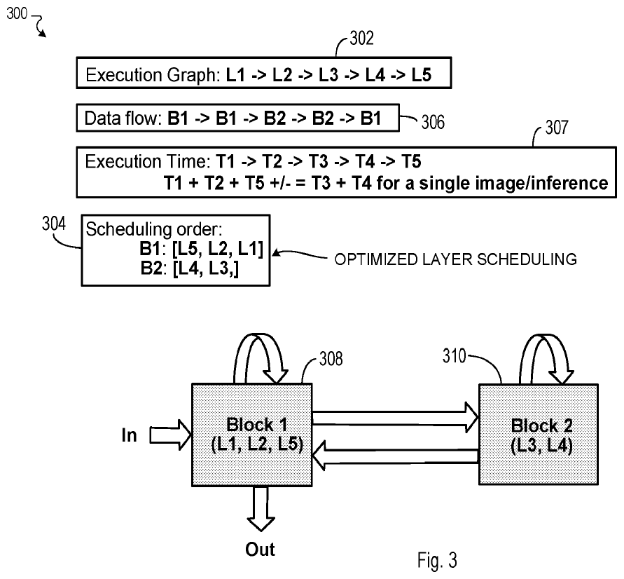

FIG. 3 illustrates an example framework 300 for tuning a multi-layer neural network. Using this framework system 100 can iteratively map computation nodes in a neural network graph unto different features of a micro-architecture (or processing engine) in a given hardware block. For example, the framework 300 may be implemented at the global tuner 202 or optimization and tuning module 112 to determine and build dependencies between various computation nodes of a neural network graph. The dependencies may be determined, for example, when a ML cost model 214 models execution of each layer of a neural network by the candidate architecture. The ML cost model 214 generates performance parameters that provide an assessment of how the candidate architecture performs when it executes each layer of the neural network.

In the example of FIG. 3, a neural network 302 includes five layers (L1-L5), where the first layer is L1, the second layer is L2, and so on. These five layers may have an initial mapping to different hardware features (e.g., processing engine) of a candidate architecture. For example, each of the five layers may be mapped to different cells of a systolic array, different systolic array blocks, different multiply-accumulate cells (MACs) of a compute tile, or different compute tiles. In some implementations, individual cells of a systolic array and individual MACs of a compute tile represent aspects of a microarchitecture of the candidate architecture.

The cost models 214 can compute performance estimates against the candidate architecture that executes neural network 302. The performance estimates include parameters indicating time durations for processing a given layer, overall processing latency, and PE utilization. The cost model 214 processes the time durations to generate a neural architecture schedule 304 that is optimized for a set of timing constraints. Based on the performance estimates, the global tuner 202 can determine that the time required to compute layers L1+L2+L5 is roughly the same as the time required to compute layers L3+L4.

Based on this determination, the global tuner 202 can remap layers L1, L2, and L5 to reuse the same hardware feature, B1, whereas layers L3 and L4 can be remapped to reuse the same hardware feature, B2 (306). In some examples, B1 and B2 are respective processing engines 308, 310, such as a compute tile or systolic array, a MAC, a systolic array cell, or even an arithmetic logic unit (ALU) of a vector-processing lane of a VPU. The global tuner 202 can perform the remap as part of a tuning operation to reduce processing latency and optimize the candidate architecture to execute the neural network model in accordance with latency requirements specified in an objective 102.

For a given neural network, each layer may require a different computation cycle. For example, after spatial remapping, some PEs may experience more idle time than others due to computational imbalance. This can be referred to as load imbalance. System 100 can account for, or overcome, load imbalance by leveraging tuning and optimization mechanisms that allow at least for PE re-use across different layers in a temporal fashion. For example, the tuner 116 and the scheduler/mapper 118 can detect the load imbalance and adjust the candidate architecture's attributes to balance the computation cycles in each PE evenly.

As noted above, the five layers of neural network 302 may have an initial mapping where each layer is mapped to different hardware features (e.g., processing engine) of a candidate architecture. Performance estimates for this initial mapping can include utilization parameters that indicate low utilization of the overall compute capability at each processing engine to which a layer may be mapped. Based on these estimates and parameters, the global tuner 202 may also perform a remap to increase processing utilization, for example, by remapping layers L1, L2, and L5 to reuse the same processing engine, B1, and remapping layers L3 and L4 to reuse the same processing engine, B2. This remapping may be performed to increase the overall utilization at each of B1 and B2 and optimize the candidate architecture to execute the neural network model in accordance with utilization (and latency) requirements specified in the objective 102.

The global tuner 202 can tune the candidate architecture to reallocate other operations to any remaining PEs (e.g., B3, B4, 85). In some cases, the global tuner 202 engages the design space explorer 212 to augment a hardware layout of the candidate architecture to reduce the number of PEs (e.g., from five to two). In some other cases, the global tuner 202 engages the design space explorer 212 to reconfigure the PEs to increase an amount of parallelism across at least B1 and B2. The global tuner 202 may determine that the remaining PEs (e.g., B3, B4, B5) are required to process smaller datasets after the remapping. Based on this determination, the global tuner 202 can, for example, adjust the compute to memory ratios of a microarchitecture of these PEs to optimize the size and utilization of the PEs for processing the smaller datasets.

The framework 300 can correspond to an example algorithm or compute sequence that takes, as inputs, a neural network graph, along with application level objectives (e.g., inference time, throughput, power, etc.), and applicable hardware constraints 110, 210. Global tuner 202 can use framework 300 as a basis for performing per-layer spatial mapping explorations on a variety of architectural knobs. A variety of architectural knobs may be supported by the framework 300, such architectural knobs can include: i) design style such as systolic array or fully unrolled design; ii) a number of mappers (e.g., systolic array clusters); iii) a number of systolic arrays per cluster; iv) input and output tiling; and v) hardware dimension transformation for dense layers.

Each remap or tuning to achieve optimization for a given constraint 210 may trigger a corresponding adjustment to the candidate architecture with regard to another constraint. For example, the remap with regard to B1 and B2 to optimize for a given timing or latency constraint may require an increase in a throughput requirement for the PEs. Thus, various architecture knobs will often need to be refined to meet new (or other existing) requirements. In some implementations, system 100 iterates through its tuning of the candidate architecture to balance the interplay between at least latency, timing, and utilization to optimize the candidate architecture for each of these constraints. In some other implementations, system 100 balances the interplay between several constraints, variables, and objectives.

Each of the architectural knobs can have a positive or negative impact on the end-to-end application performance. Further, each of the architectural knobs can also influence the effect of the architecture knobs in another layers' mapping. Thus, based at least on the machine-learning aspects of its control logic and the architecture-aware cost model 114, system 100 is configured to provide a holistic view of a candidate architecture under evaluation to accurately predict these positive and negative impacts.

A candidate architecture can include multiple processing engines and one or more layers can be mapped to a separate processing engine based on predefined merging rules (e.g. conv2d+BN+activation merging; conv2d+maxpooling merging). Merging rules can be pre-defined, for example, as instructions or coded rules in network graph module 108. In some implementations, two or more graph nodes (or layers) are merged if a next layer's computation can be performed in line with a previous layer's computation (e.g., conv2d (+BN)+activation). As an example, computations for a batch normalization (BN) layer may be merged with computations for a 2D convolutional layer. Also, for each layer output that is provided as an input to a subsequent layer, if the amount of input and computation for the subsequent layer is of a threshold size and has a particular spatial and temporal locality, then this subsequent layer can be merged with the previous layer that generated the layer output. An example of this may correspond to a layer output of a 2D convolutional layer that is provided as an input to a pooling layer (e.g., conv2d+pooling).

In some implementations, to tune a candidate architecture, the global tuner 202 performs an initial mapping of respective layers to a corresponding PE and generates performance estimates for the initial mapping. Based on the performance estimates for the initial mapping, the global tuner 202 can iteratively map different combinations of layers to PEs to tune the initial mapping. The global tuner 202 generates performance estimates for each iteration and identifies a mapping for which the performance estimates coincide with a set of PPA constraints of the objectives 102.

When tuning a candidate architecture, the global tuner 202 uses one or more cost models 214 to iterate through different mappings and compute performance parameters for each mapping. From the performance parameters, the system 100 identifies a mapping of computations that performs optimally for a given set of PPA constraints 210. In some implementations, the system 100 can iteratively map computation nodes for different vector operations to a subset of vector processing lanes in a VPU with temporal mappings that specify the sequences of nodes that operate within the processing lanes.

In some implementations, the framework 300 uses the architecture-aware analytical cost model 114 to predict the cost of each trial (hardware/neural configuration) due to: (1) a cycle accurate simulation for each trial is time-consuming and there are often millions to billions of unique design points to evaluate; (2) since a neural network's computation is compute intensive and can be expressed with nested loops, an analytical model can be constructed with high fidelity. The optimization and tuning module 112 samples the search space, queries the cost models 114 for the cost of each design point, and follows a particular exploration trajectory to search the design space 104. The cost of each design point and exploration trajectory of the design space 104 are implemented to optimize a candidate architecture at least by tuning the architecture to minimize a processing cost of each design point. In some cases, the exploration trajectory is different for different tuner algorithms employed by tuner 116.

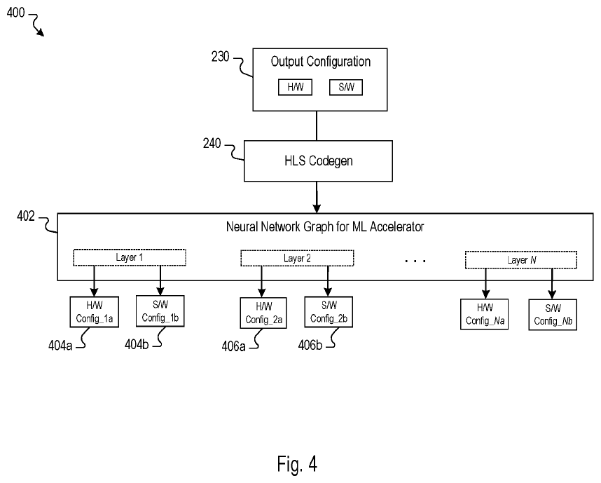

FIG. 4 is a flow diagram of an example process 400 relating to a graph execution schedule of a multi-layer neural network. As described above, the global tuner 202 generates an output configuration 230 that is used to automatically generate an application-specific ML accelerator. The system 200 translates data representing the output configuration 230 to HLS code using an example code generation module 240.

The neural network graph 402 is for a customized application-specific ML accelerator and indicates example allocations or mappings for a set of neural network layers. In the example of FIG. 4, a first neural network layer L1 may be mapped to a given PE based on a particular hardware configuration 404a and software configuration 404b, whereas a second, different neural network layer L2 may be mapped to a given PE based on a particular hardware configuration 406a and software configuration 406b. In some implementations, the L1 and L2 may be mapped to the same PE or to different PEs.

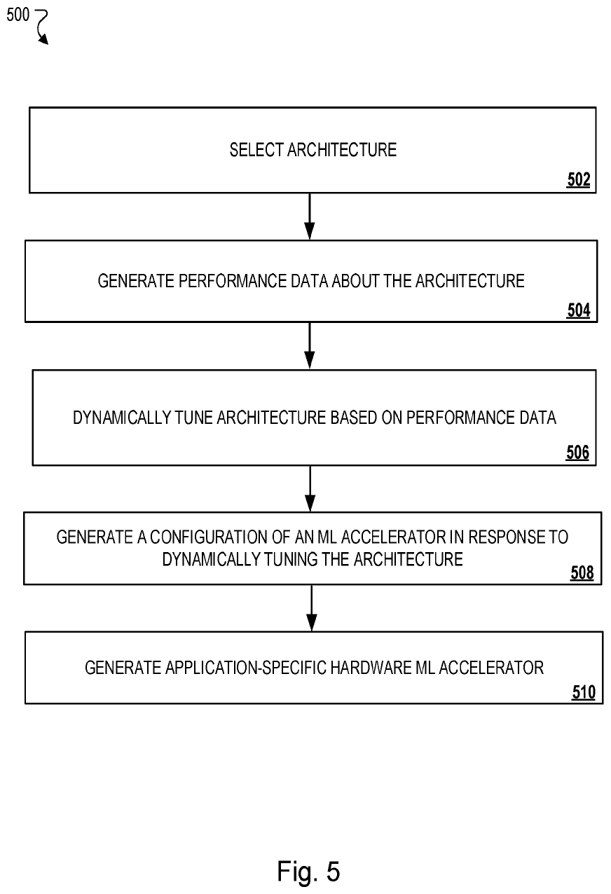

FIG. 5 is a flow diagram that illustrates an example process 500 for generating and globally tuning an application-specific machine-learning accelerator. Process 500 can be implemented or executed using the system 100 described above. Descriptions of process 500 may reference the above-mentioned computing resources of system 100. The steps or actions of process 500 may be enabled by programmed firmware, or software instructions, that are executable by one or more processors of the devices and resources described in this document.

Referring now to process 500, system 100 selects an architecture (502). For example, a controller of system 100 can select a candidate architecture that represents a baseline processor configuration. The candidate architecture can include a hardware architecture and a neural architecture corresponding to a neural network graph. In some implementations, the architecture is identified and selected based on search operations performed by the design space builder 204 and design space explorer 212 against the hardware layouts of architecture repository 104 and neural architectures of network graph module 108.

System 200 can implement NAS and hardware architecture search techniques based on one or more tuner variables or PPA constraints 210. The PPA constraints can be user specified objectives 102 that define performance requirements of a hardware accelerator. For example, the requirements can be thresholds for processor utilization, power consumption, processing latency, and data throughput. In some implementations, selecting the architecture includes obtaining input criteria that specifies a performance objective and identifying multiple candidate architectures for implementing a special-purpose processor. For example, control logic for managing design space 104, which includes design space builder 204 and explorer 212, can select a candidate architecture from among multiple candidate architectures based on the input criteria.

System 100 generates performance data about the architecture (504). For example, an ML cost model 214 generates performance data about the candidate architecture at least by modelling how the architecture executes computations of a first neural network that includes multiple neural network layers. In some implementations, the neural network is a known neural network, such as the multi-layer ResNet-50, which is a convolutional neural network that is 50 layers deep.

System 100 dynamically tunes the architecture based on the performance data (506). For example, based on the performance data, the optimization and tuning module 112 dynamically tunes the candidate architecture to satisfy one or more performance objectives. More specifically, the optimization and tuning module 112 interacts with the architecture-aware cost models 114 to model the candidate architecture's execution of each layer of the neural network. For example, the ML cost model 214 generates performance parameters that provide an assessment of how the candidate architecture performs when it executes each layer of the neural network.

System 100 uses the tuning loop 122 to evaluate, tune, and optimizes the architecture's implementation of the first neural network based on the performance parameters. In some implementations, the system 100 uses global tuning (e.g., via global tuner 202) to discover system-wise optimized per-op mappings for efficient neural network execution on target hardware platforms. In some other implementations, the system 100 uses global tuning to discover an optimized graph execution schedule whenever it is allowed, such as processing engines (PE) reuse across multiple layers. This is described above with reference to FIG. 3.

For example, the global tuner 202 is configured to tune a candidate architecture by remapping two or more layers (e.g., L1, L2, L5) to the same subset of compute tiles or MACs, to optimize selected neural architectures for a target application. The architectures may be optimized for example applications such as a training/inference device or an image classification workload. The control logic of system 100 can use the timing of clocked signals to, at appropriate times, send instructions and control signals to each of the optimization and tuning module 112 and architecture-aware cost model 114 to generate performance data that is used to accomplish the remap. The optimization and tuning module 112 is configured to perform application-specific tuning and optimization for generating hardware layouts of integrated circuits that accelerate ML workloads. The optimization and tuning module 112 (and the cost model 114) can incorporate some (or all) functionality of the global tuner 202 such that descriptions of operations performed by the global tuner 202 translate to operations of the optimization and tuning module 112.

System 100 generates a configuration of an ML accelerator in response to dynamically tuning the architecture (508). In some implementations, the tuning and optimization of step 506 is embodied in an output configuration 230 that allows for generating special-purpose integrated circuits with hardware architectures that are customized on a layer-by-layer basis. This aspect of customization can enable a hardware ML accelerator circuit to achieve orders of magnitude improvements in energy efficiency relative to prior approaches that are based on a single generic hardware block.

For example, after optimization and tuning of a candidate architecture, system 100 generates compatible hardware configurations 230 which include various architecture features and scheduling/mapping strategies so that it can be used by at least the code generation module 240 to generate an application-specific ML accelerator. The system 200 translates data representing the configurations 230 to High-level synthesis (HLS) code using the code generation module 240. The code generation module 240 can create firmware implementations of ML algorithms for a hardware accelerator using high-level synthesis language (HLS). System 100 can then generate an application-specific hardware ML accelerator based on the firmware implementations and HLS operations (510).

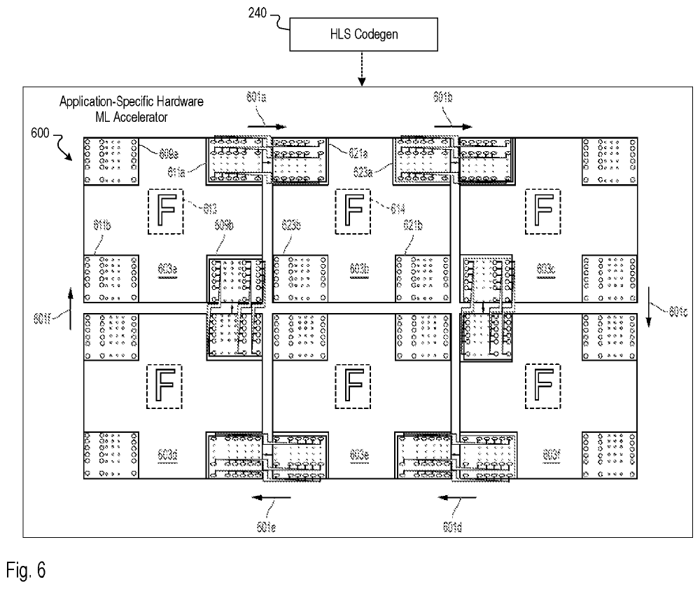

FIG. 6 is a block diagram of an example application-specific hardware ML accelerator 600. Hardware accelerator 600 is generated using the techniques disclosed in this document, including at least the example operations of systems 100 and 200. Using the code generator 240, the system 100 is configured to generate a hardware layout for an application-specific ML accelerator 600 that specifies respective portions of hardware circuitry, each of which may be customized to run a particular layer of a neural network.

Hardware accelerator 600 can use separate hardware blocks 603a, 603b, 603c, 603d, 603e, 603f to execute one or more layers (e.g., if they share common properties) in a streaming and pipelined manner. Each hardware block 603 is tailored specifically to those layers (e.g., quantization, layer specific tiling, systolic array dimensions, etc.) to enable, for example, low power and high utilization across hardware accelerator 600. In some implementations, each hardware block 103 has an association or mapping with a particular layer of a neural network and the association of a hardware block 103 with a layer (e.g., L1, L2, L3, L4, or L5, discussed above) of a neural network is based in part on the features and optimization efforts related to that layer of the neural network.

Data flow indications 601a, 601b, 601c, 601d, 601e, 601f provide an example sequence of communicating data of the neural network between the hardware blocks 603. In some implementations, these data flow indications 601a, 601b, 601c, 601d, 601e, 601f are for example communication sequences that are preconfigured based on the optimization and tuning operations of the global tuner 202. The neural network data that is communicated can include computation result data such as the output of a computation unit at a particular hardware block 603, neural network inputs/activations, parameter weight data, and other neural network parameter related data.

Each hardware block 603 can include microarchitectures that are customized for a target application. The global tuner 202 is configured to optimize communications across different hardware blocks in its global tuning operations to balance an architecture's design at system level. Such optimizations include interface tiling for rate matching in data transfer, number of compute blocks (e.g., input channel blocking) for rating matching in computations, buffer sizing, etc. For example, hardware block 603a can include inter-die input blocks 606a, 609b, inter-die output blocks 611a, 611b, and a host-interface unit 613, whereas hardware block 603b includes inter-die input blocks 621a, 621b, inter-die output blocks 623a, 623b, and the host-interface unit 614.

The customized configuration of accelerator 600 can include a first layer of the neural network being mapped to hardware block 603a and a final layer of the neural network being mapped to hardware block 603d. The global tuner 202 can configure this architecture to incorporate, for example, a feedback layer between hardware blocks 603a, 603d to balance the interplay between per-op spatial mappings for efficient neural network execution and a size/area constraint of the PPA constraint 210. For example, the hardware accelerator 600 is configured to use the least amount of hardware to perform neural networks computation efficiently while still being able to match throughput/latency based on application specific requirements.

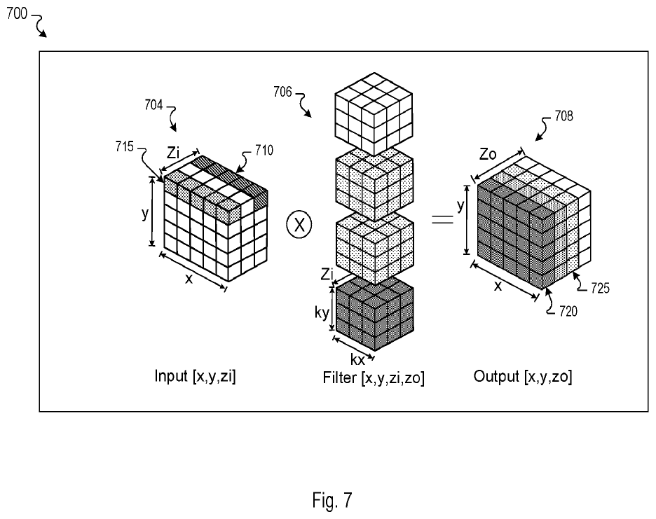

FIG. 7 illustrates examples of tensors or multi-dimensional matrices 700 that include an input tensor 704, variations of a weight tensor 706, and an output tensor 708. Tensors 700 are example machine-learning data structures that are processed or generated using a ML hardware accelerator, such as accelerator 600. For example, the system 100 can be used to tune and optimize a candidate architecture for processing at least tensors 704 and 706, and automatically generate a customized hardware ML accelerator 600 configured to implement a neural network that receives and processes data associated with these tensors.

Each of the tensors 700 include elements that correspond to data values for computations performed at a given layer of a neural network. The computations can include multiplication of an input/activation tensor 704 with a parameter/weight tensor 706 on one or more clock cycles to produce outputs such as activation/output values that can be provided as inputs to another neural network layer. In the example of FIG. 7, each output in a set of outputs can correspond to a respective element of output tensor 708. In some examples input tensor 704 is an activation tensor. Multiplying an activation tensor 704 with a corresponding weight tensor 706 includes multiplying an activation from an element of tensor 704 with a weight from an element of tensor 706 to produce a partial sum(s).

In some implementations, the hardware blocks 603 of the ML accelerator 600 are respective processor cores that operate on vectors, which can include multiple discrete elements along a same (or different) dimension of some multi-dimensional tensor. Each of the multiple elements can be represented using X,Y coordinates (2D) or using X, Y,Z coordinates (3D) depending on the dimensionality of the tensor. The hardware layout of ML accelerator 600 can be optimized to compute multiple partial sums in accordance with a given set of PPA constraints. The partial sums correspond to products generated from multiplying a batch inputs with corresponding weight values.

An input-weight multiplication may be written as a sum-of-product of each weight element multiplied with discrete inputs of an input volume, such as a row or slice of the input tensor 704. This row or slice can represent a given dimension, such as a first dimension 710 of the input tensor 704 or a second, different dimension 715 of the input tensor 704. The dimensions may be mapped to various vector processing units across the hardware blocks 603 such that ML accelerator 600 routinely performs its computations in a manner that precludes load imbalances and achieves threshold processing utilizations at each hardware block 603, in accordance with a given set of input objectives 102.

In some implementations, an example set of computations can be used to compute an output for a convolutional neural network layer. The computations for the CNN layer can involve performing a 2D spatial convolution between a 3D input tensor 704 and at least one 3D filter (weight tensor 706). For example, convolving one 3D filter 706 over the 3D input tensor 704 can produce a 2D spatial plane 720 or 725. The computations can involve computing sums of dot products for a particular dimension of the input volume. For example, the spatial plane 720 can include output values for sums of products computed from inputs along dimension 710, whereas the spatial plane 725 can include output values for sums of products computed from inputs along dimension 715. The computations to generate the sums of the products for the output values in each of spatial planes 720 and 725 can be performed using the hardware blocks 603 that are generated and tuned using the techniques described in this document.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus.

Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “computing system” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array), an ASIC (application specific integrated circuit), or a GPGPU (General purpose graphics processing unit).

Computers suitable for the execution of a computer program include, by way of example, can be based on general or special purpose microprocessors or both, or any other kind of central processing unit. Generally, a central processing unit will receive instructions and data from a read only memory or a random access memory or both. Some elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A computer-implemented method for generating an application-specific machine-learning (ML) accelerator, the method comprising:
selecting an architecture that represents a baseline processor configuration;
modelling, using an ML cost model, how the architecture executes computations of a first neural network that includes a plurality of layers;
generating, by the ML cost model, performance data about the architecture in response to modelling the architecture executing computations of the first neural network;
based on the performance data, dynamically tuning the architecture to satisfy a performance objective that represents an expected performance of the architecture when the architecture implements the first neural network and executes machine-learning computations for a target application;
in response to dynamically tuning the architecture, determining customized hardware configurations for implementing each of the plurality of layers of the first neural network; and
generating a configuration of an ML accelerator based on the dynamically tuned architecture and the customized hardware configurations.

2. The method of claim 1, further comprising:
generating an application-specific hardware ML accelerator based on the customized hardware configurations,
wherein the application-specific hardware ML accelerator is optimized to implement each of layer of the plurality of layers of the first neural network when the first neural network is used to execute computations for the target application.

3. The method of claim 2, wherein the performance objective comprises a plurality of discrete objectives and generating the application-specific ML accelerator comprises:
generating an application-specific hardware ML accelerator configured to satisfy each discrete objective of the plurality of discrete objectives when the application-specific hardware ML accelerator executes computations for the target application.

4. The method of claim 3, wherein generating the performance data comprises:
modeling, by the ML cost model, use of the architecture to execute each layer of the plurality of layers of the first neural network; and
in response to modelling use of the architecture to execute each layer, generating, by the ML cost model, performance parameters of the architecture for each of the plurality of layers.

5. The method of claim 4, wherein:
the performance parameters correspond to each discrete objective of the plurality of discrete objectives; and
the plurality of discrete objectives comprises at least one of: a threshold processing latency, a threshold power consumption, a threshold data throughput, and a threshold processor utilization.

6. The method of claim 2, wherein dynamically tuning the architecture comprises:
determining, for an input tensor, a mapping of computations that causes the application-specific hardware ML accelerator to utilize a threshold percentage of hardware computing units of the hardware ML accelerator when the application-specific hardware ML accelerator processes the input tensor; and
dynamically tuning the architecture based on the determined mapping.

7. The method of claim 6, wherein dynamically tuning the architecture comprises:
dynamically tuning the architecture based on operations performed by each of a plurality of ML cost models of a global tuner; and
dynamically tuning the architecture based on operations performed by at least one of a random tuner or a simulated annealing tuner of the global tuner.

8. The method of claim 6, wherein the architecture is for an integrated circuit, comprises one or more hardware blocks of the integrated circuit, and dynamically tuning the architecture comprises:
for each of the one or more hardware blocks:
dynamically tuning the architecture to satisfy a respective performance objective for the hardware block when the architecture implements the first neural network and executes computations for the target application using the first neural network.

9. The method of claim 6, wherein:
the configuration of the hardware ML accelerator specifies customized software configurations for the first neural network; and
generating the application-specific hardware ML accelerator comprises, generating the application-specific hardware ML accelerator based on the customized hardware configurations and the customized software configurations.

10. The method of claim 6, wherein:
the ML cost model is an architecture-aware cost model that includes one or more individual analytical models; and
the architecture-aware cost model is configured to estimate performance of the architecture based on a deterministic dataflow of data that is processed using the architecture.

11. A system comprising a processing device and a non-transitory machine-readable storage device storing instructions for generating an application-specific machine-learning (ML) accelerator, the instructions being executable by the processing device to cause performance of operations comprising:
selecting an architecture that represents a baseline processor configuration;
modelling, using an ML cost model, how the architecture executes computations of a first neural network that includes a plurality of layers;
generating, by the ML cost model, performance data about the architecture in response to modelling the architecture executing computations of the first neural network;
based on the performance data, dynamically tuning the architecture to satisfy a performance objective that represents an expected performance of the architecture when the architecture implements the first neural network and executes machine-learning computations for a target application;
in response to dynamically tuning the architecture, determining customized hardware configurations for implementing each of the plurality of layers of the first neural network; and
generating a configuration of an ML accelerator based on the dynamically tuned architecture and the customized hardware configurations.

12. The system of claim 11, further comprising:
generating an application-specific hardware ML accelerator based on the customized hardware configurations,
wherein the application-specific hardware ML accelerator is optimized to implement each of layer of the plurality of layers of the first neural network when the first neural network is used to execute computations for the target application.

13. The system of claim 12, wherein the performance objective comprises a plurality of discrete objectives and generating the application-specific ML accelerator comprises:
generating an application-specific hardware ML accelerator configured to satisfy each discrete objective of the plurality of discrete objectives when the application-specific hardware ML accelerator executes computations for the target application.

14. The system of claim 13, wherein generating the performance data comprises:
modeling, by the ML cost model, use of the architecture to execute each layer of the plurality of layers of the first neural network; and
in response to modelling use of the architecture to execute each layer, generating, by the ML cost model, performance parameters of the architecture for each of the plurality of layers.

15. The system of claim 14, wherein:
the performance parameters correspond to each discrete objective of the plurality of discrete objectives; and
the plurality of discrete objectives comprises at least one of: a threshold processing latency, a threshold power consumption, a threshold data throughput, and a threshold processor utilization.

16. The system of claim 12, wherein dynamically tuning the architecture comprises:
determining, for an input tensor, a mapping of computations that causes the application-specific hardware ML accelerator to utilize a threshold percentage of hardware computing units of the hardware ML accelerator when the application-specific hardware ML accelerator processes the input tensor; and
dynamically tuning the architecture based on the determined mapping.

17. The system of claim 16, wherein dynamically tuning the architecture comprises:
dynamically tuning the architecture based on operations performed by each of a plurality of ML cost models of a global tuner; and
dynamically tuning the architecture based on operations performed by at least one of a random tuner or a simulated annealing tuner of the global tuner.

18. The system of claim 16, wherein the architecture is for an integrated circuit, comprises one or more hardware blocks of the integrated circuit, and dynamically tuning the architecture comprises:
for each of the one or more hardware blocks:
dynamically tuning the architecture to satisfy a respective performance objective for the hardware block when the architecture implements the first neural network and executes computations for the target application using the first neural network.

19. The system of claim 16, wherein:
the ML cost model is an architecture-aware cost model that includes one or more individual analytical models; and
the architecture-aware cost model is configured to estimate performance of the architecture based on a deterministic dataflow of data that is processed using the architecture.

20. A non-transitory machine-readable storage device storing instructions for generating an application-specific machine-learning (ML) accelerator, the instructions being executable by the processing device to cause performance of operations comprising:
selecting an architecture that represents a baseline processor configuration;
modelling, using an ML cost model, how the architecture executes computations of a first neural network that includes a plurality of layers;
generating, by the ML cost model, performance data about the architecture in response to modelling the architecture executing computations of the first neural network;
based on the performance data, dynamically tuning the architecture to satisfy a performance objective that represents an expected performance of the architecture when the architecture implements the first neural network and executes machine-learning computations for a target application;
in response to dynamically tuning the architecture, determining customized hardware configurations for implementing each of the plurality of layers of the first neural network; and
generating a configuration of an ML, accelerator based on the dynamically tuned architecture and the customized hardware configurations.
